(19) United States
(12) Patent Application Publication
(10) Pub. No.: US 2005/0012309 A1
(43) Pub. Date: Jan. 20, 2005

(54) Inflation fluid distribution manifold

(75) Inventors: Jay D. Blackson, Dryden, MI (US); Michael P. Pionk, Marysville, MI (US); Ayad E. Nayef, Sterling Hts., MI (US); Navin Chopra, Rochester Hills, MI (US)

Correspondence Address: TAROLLI, SUNDHEIM, COVELL, & TUMMINO L.L.P., 1111 LEADER BLDG., 526 SUPERIOR AVENUE, CLEVELAND, OH, 44114-1400, US

(73) Assignee: TRW Vehicle Safety Systems Inc.

(21) Appl. No.: 10/620,784

(22) Filed: Jul. 16, 2003

(51) Int. Cl. B60R 21/22

(52) U.S. Cl. 280/730.2

(57) ABSTRACT

Apparatus (10) for helping to protect an occupant of a vehicle (12) that has a side structure (16) and a roof (18) includes an inflatable curtain (14) that has an inflatable volume (34). A first fill tube (42) has a portion positioned in a first portion (50) of the inflatable volume (34). A second fill tube (44) has a portion positioned in a second portion (52) of the inflatable volume (34). An inflation fluid distribution manifold (70) is connectable with an inflator (40). The manifold (70) includes a first flow orifice (196) that directs inflation fluid to flow into the first fill tube (42) at a first flow rate. The manifold (70) includes a second flow orifice (198) that directs inflation to fluid flow into the second fill tube (44) at a second flow rate different than the first flow rate.

### FIELD OF THE INVENTION

The present invention relates to an apparatus for helping to protect an occupant of a vehicle. More particularly, the present invention relates to an apparatus including an inflatable curtain and an inflation fluid distribution manifold for helping to direct inflation fluid from an inflator to the inflatable curtain.

### BACKGROUND OF THE INVENTION

It is known to inflate an inflatable vehicle occupant protection device to help protect a vehicle occupant in the event of a vehicle collision. One particular type of inflatable vehicle occupant protection device is an inflatable curtain that is inflatable in the event of a side impact to the vehicle or a vehicle rollover. The inflatable curtain inflates away from the roof of the vehicle downward inside the passenger compartment between a vehicle occupant and the side structure of the vehicle. A known inflatable curtain is inflated with inflation fluid directed from an inflator to the inflatable curtain.

### SUMMARY OF THE INVENTION

The present invention relates to an apparatus for helping to protect an occupant of a vehicle that has a side structure and a roof. The apparatus includes an inflatable curtain that is inflatable away from the roof between the side structure of the vehicle and a vehicle occupant. The inflatable curtain has an inflatable volume. An inflator is actuatable to provide inflation fluid for inflating the inflatable curtain. A first fill tube has a portion positioned in a first portion of the inflatable volume. A second fill tube has a portion positioned in a second portion of the inflatable volume. An inflation fluid distribution manifold is connectable with the inflator. The manifold includes a first flow orifice that directs inflation fluid to flow into the first fill tube at a first flow rate. The manifold includes a second flow orifice that directs inflation to fluid flow into the second fill tube at a second flow rate different than the first flow rate.

The present invention also relates to an inflation fluid distribution manifold for directing inflation fluid from an inflator to an inflatable curtain that is inflatable away from a vehicle roof between a side structure of the vehicle and a vehicle occupant. The manifold includes a collar portion including first and second collar parts, each of which has an inner surface. The first and second collar parts are connectable with each other such that the inner surfaces encircle and engage an outlet portion of the inflator to clamp the collar portion onto the outlet portion of the inflator. The manifold also includes a main fluid passage that is in fluid communication with an inflation fluid outlet of the outlet portion of the inflator while the collar portion is clamped onto the outlet portion. A first distribution passage in fluid communication with the main fluid passage includes a first flow orifice that helps direct inflation fluid to flow into the inflatable curtain at a first flow rate. A second distribution passage in fluid communication with the main fluid passage includes a second flow orifice that helps direct inflation fluid to flow into the inflatable curtain at a second flow rate different than the first flow rate.

### BRIEF DESCRIPTION OF THE DRAWINGS

The foregoing and other features of the present invention will become apparent to one skilled in the art to which the present invention relates upon consideration of the following description of the invention with reference to the accompanying drawings, in which:

FIG. 1 is a schematic view of an apparatus for helping to protect a vehicle occupant, according to a first embodiment of the present invention;

FIG. 2 is an exploded perspective view of a portion of the apparatus of FIG. 1;

FIG. 3 is a sectional view of the portion of the apparatus of FIG. 2 in an assembled condition;

FIG. 4 is an exploded perspective view of a portion of the apparatus of FIG. 1 according to a second embodiment of the present invention; and

FIG. 5 is a sectional view of the portion of the apparatus of FIG. 4 in an assembled condition.

### DESCRIPTION OF PREFERRED EMBODIMENTS

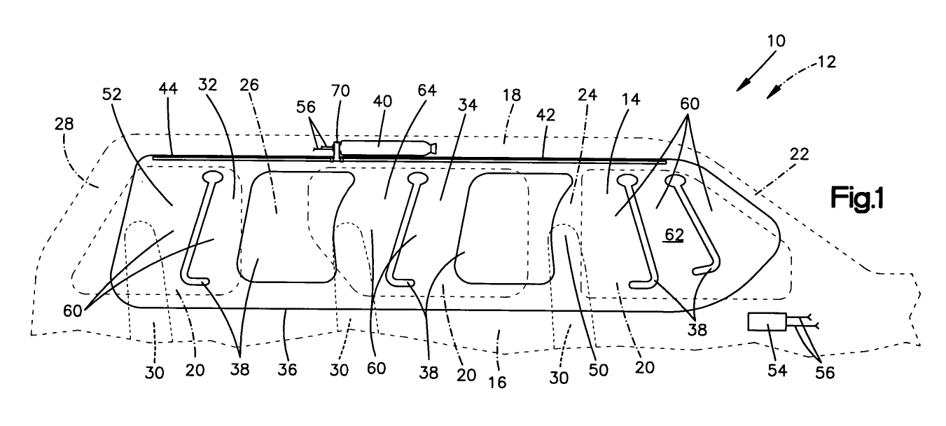

As representative of the present invention, an apparatus 10 helps to protect an occupant of a vehicle 12. As shown in FIG. 1, the apparatus 10 includes an inflatable vehicle occupant protection device in the form of an inflatable curtain 14 that is mounted along the side structure 16 of the vehicle 12 and a roof 18 of the vehicle. The side structure 16 of the vehicle 12 includes side window openings 20, an A pillar 22, a B pillar 24, a C pillar 26, and a D pillar 28. The inflatable curtain 14 extends from the A pillar 22 to the D pillar 28. The vehicle 12 also includes seats 30. In the embodiment of FIG. 1, the vehicle 12 includes seats arranged in a first, second, and third row.

FIG. 1 illustrates an exemplary configuration of the apparatus 10. The vehicle 12 and/or the inflatable curtain 14 may have configurations alternative to those illustrated in FIG. 1. For example, the side structure 16 may not include a D pillar, in which case the C pillar 26 would be the rearwardmost pillar of the vehicle 12. Also, the inflatable curtain 14 may cover a different portion of the side structure 16 of the vehicle 12, such as from the A pillar 22 to the C pillar 28. This may be the case, for example, where the vehicle 12 does not include a third row of seats 30.

The inflatable curtain 14 includes overlying panels 32 that are interconnected to define an inflatable volume 34 of the curtain. The panels may be interconnected along a perimeter 36 of the inflatable curtain 14 to help define the inflatable volume 34. The panels may also be interconnected within the perimeter 36 at connections 38 that further help to define the inflatable volume 34. The connections 38 may also help define non-inflatable portions of the inflatable curtain 14.

An inflator 40 is adapted to provide inflation fluid to the inflatable volume 34 to inflate the inflatable curtain 14. In the embodiment of FIG. 1, the apparatus 10 includes a first fill tube 42 and a second fill tube 44, each of which has a portion located in the inflatable curtain 14. The portions of the first and second fill tubes 42 and 44 positioned in the inflatable curtain 14 have a plurality of openings (not shown) that provide fluid communication between the fill tubes and the inflatable volume 34 of the curtain.

The first fill tube 42 has a portion located in a front portion 50 of the inflatable curtain 14. The front portion 50 extends generally forward of the C pillar 26, from the C pillar to the A pillar 22. The second fill tube 44 has a portion located in a rear portion 52 of the inflatable curtain 14. The rear portion 52 extends generally from the C pillar 26 rearward to the D pillar 28.

The inflator 40 contains a stored quantity of pressurized inflation fluid (not shown) in the form of a gas for inflating the inflatable curtain 14. The inflator 40 alternatively could contain a combination of pressurized inflation fluid and ignitable material for heating the inflation fluid, or could be a pyrotechnic inflator that uses the combustion of gas-generating material to generate inflation fluid. As a further alternative, the inflator 40 could be of any suitable type or construction for supplying a medium for inflating the inflatable curtain 14.

The apparatus 10 has a stored condition (not shown) in which the inflatable curtain 14 is stowed in a deflated condition. When the apparatus 10 is in the stored condition, the deflated inflatable curtain 14 has an elongated configuration and extends along the vehicle roof 18 and along the side structure 16 of the vehicle 12 above the side window openings 20.

The vehicle 12 includes a sensor mechanism 54 (shown schematically in FIG. 1) for sensing the occurrence of an event for which inflation of the inflatable curtain 14 is desired, such as a side impact to the vehicle 12 and/or a rollover of the vehicle. Upon sensing such an event, the sensor mechanism 54 provides an electrical signal over lead wires 56 to the inflator 40. The electrical signal causes the inflator 40 to be actuated in a known manner. The inflator 40 discharges fluid under pressure into the first and second fill tubes 42 and 44. The first fill tube 42 directs inflation fluid into the front portion 50 of the inflatable curtain 14. The second fill tube 44 directs inflation fluid into the rear portion 52 of the inflatable curtain 14.

The inflatable curtain 14 inflates under the pressure of the inflation fluid from the inflator 40. The inflatable curtain 14 inflates away from the roof 18 in a downward direction as shown in the drawings and in a downward direction with respect to the direction of forward travel of the vehicle 12 into an inflated position, as illustrated in FIG. 1. The inflatable curtain 14, when in the inflated position, extends along the side structure 16 of the vehicle 12 and is positioned between the side structure and any occupant of the vehicle.

The apparatus 10 may also include means (not shown) for helping to tension the inflatable curtain 14 when the curtain is inflated. For example, the apparatus 10 may include tethers for connecting opposite ends of the inflatable curtain 14 to the vehicle 12 (e.g., to the A pillar 22 and D pillar 28). As another example, the apparatus 10 may include a slider mechanism, such as a sliding ratchet mechanism, for connecting the inflatable curtain to the vehicle 12. As another example, the inflatable curtain 14 may be connected to the vehicle 12 along the A pillar 22 and D pillar 28. As a further example, the apparatus 10 may include an active device, such as a piston/cylinder arrangement, that is actuatable to apply tension the inflatable curtain 14.

The inflatable curtain 14, when inflated, helps to protect a vehicle occupant in the event of a vehicle rollover or a side impact to the vehicle 12. The inflatable curtain 14, when inflated, helps to absorb the energy of impacts with the curtain and helps to distribute the impact energy over a large area of the curtain.

Those skilled in the art will appreciate that it may be desirable to direct inflation fluid to flow into different portions of the inflatable curtain 14 at different flow rates. This may be desirable, for example, where even deployment of the inflatable curtain 14 is desired. By “even deployment,” it is meant that as the inflatable curtain 14 is deployed, the curtain moves away from the vehicle roof 18 in a manner such that the lower extent of the curtain remains approximately parallel with the vehicle roof. Even deployment of the inflatable curtain 14 does not necessarily mean that the curtain is inflated evenly along its length. It will be appreciated that the inflatable curtain 14 may be deployed evenly along its length while, at the same time, different portions of the curtain may be inflated (i.e., filled and pressurized with inflation fluid) at different times and/or at different rates.

For example, a front portion of the inflatable curtain 14 may have an inflatable volume different than that of a rear portion of the curtain. In this instance, in order to effectuate even deployment of the inflatable curtain 14, it may be desirable to direct inflation fluid into the front and rear portions of the curtain at flow rates commensurate with their respective volumes. As set forth in the following paragraphs, according to the present invention, the apparatus 10 is adapted to direct inflation fluid to flow into different portions of the inflatable curtain 14 at different flow rates.

In the embodiment illustrated in FIG. 1, the inflatable volume 34 of the inflatable curtain 14 includes a plurality of inflatable chambers 60. The chambers 60 are defined partially by the connections 38 of the inflatable curtain 14 and the perimeter 36 of the curtain. The front portion 50 of the inflatable curtain 14 includes an A-B portion 62 that extends between the A pillar 22 and B pillar 24. The A-B portion 62 includes three inflatable chambers 60. The front portion 50 also includes a B-C portion 64 that extends between the B pillar 24 and C pillar 26. The B-C portion 64 includes two inflatable chambers 60. The rear portion 52 includes two inflatable chambers 60 positioned generally between the C pillar 26 and D pillar 28.

In the embodiment illustrated in FIG. 1, the portion of the inflatable volume 34 occupied by the rear portion 52 of the curtain 14 is smaller than the portion of the inflatable volume occupied by the front portion 50 of the curtain. Thus, it may be desirable for the rate of inflation fluid flow into the front portion 50 of the curtain to be greater than the rate of inflation fluid flow into the rear portion 52 of the curtain.

The apparatus 10 of the present invention is adapted to provide inflation fluid to the chambers 60 of the front and rear portions 50 and 52 at flow rates related to their respective volumes. The apertures (not shown) of the first and second fill tubes 42 and 44 are positioned to direct inflation fluid into the respective chambers 60 of the front and rear portions 50 and 52. The quantity and size of the apertures may also help direct a desired amount of inflation fluid into the respective chambers 60 of the inflatable curtain 14.

According to the present invention, the apparatus 10 also includes an inflation fluid distribution manifold 70 for directing inflation fluid from the inflator 40 into the first and second fill tubes 42 and 44. The manifold 70 is adapted to provide inflation fluid to the fill tubes 42 and 44 at fluid flow rates that are different from each other. By “flow rates” it is meant to refer to the molar flow rate at which the manifold 70 directs inflation fluid into the first and second fill tubes 42 and 44. These different fluid flow rates are related to the size of the portion of the inflatable volume 34 into which the respective tubes direct the inflation fluid. More specifically, since the front portion 50 of the inflatable curtain 14 has a larger inflatable volume than the rear portion 52 of the curtain, the manifold 70 is adapted to direct inflation fluid into the front fill tube 42 at a flow rate that is higher than the flow rate at which the manifold directs inflation fluid into the rear fill tube 44.

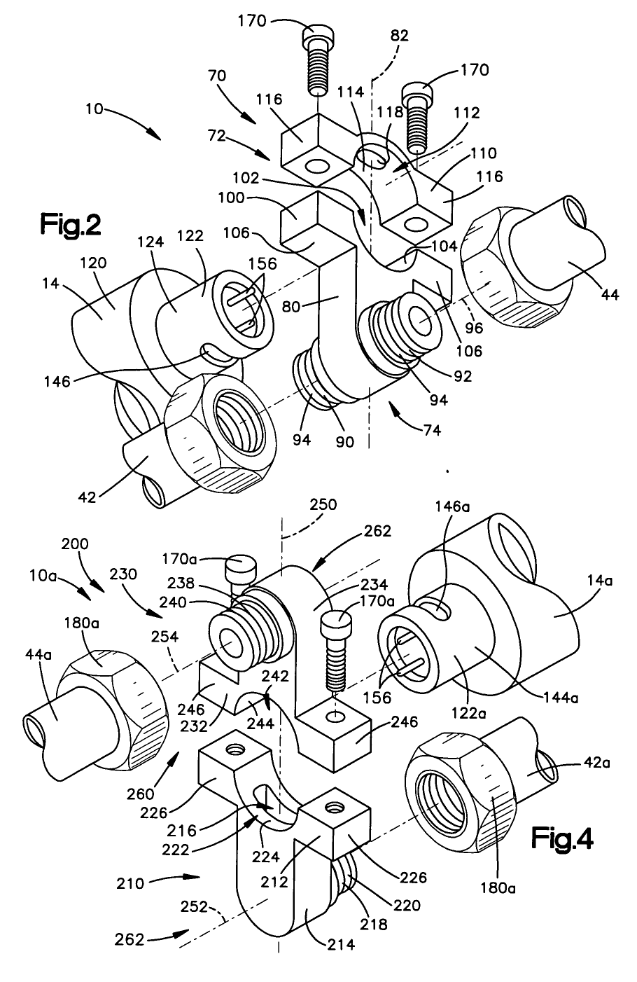

Referring to FIG. 2, the manifold 70 includes a collar portion 72 for connecting with the inflator 14 and a fluid distribution portion 74 for connecting with the first and second fill tubes 42 and 44. The collar portion 72 receives inflation fluid from the inflator 14 and directs the fluid to the fluid distribution portion 74. The distribution portion 74, in turn, directs the inflation fluid to the fill tubes 42 and 44 at desired flow rates.

The distribution portion 74 includes a main fluid passage portion 80 that is centered on and extends along an axis 82. The distribution portion 74 also includes first and second distribution portions 90 and 92, respectively, that extend in opposite directions along an axis 96 perpendicular to the axis 82. Each of the first and second distribution portions 90 and 92 has a generally cylindrical configuration and includes a series of screw threads 94 on its respective outer surface.

The collar portion 72 includes first and second collar parts 100 and 110. The first collar part 100 is formed at an end of the main fluid passage portion 80 opposite the distribution portions 90 and 92. The first collar part 100 includes a central clamping portion 102 that has a semi-cylindrical clamping surface 104. The first collar part 100 also includes flanges 106 positioned on opposite sides of the clamping portion 102.

The second collar part 110 is formed as a piece of material separate from the first collar part 100. The second collar part 110 includes a central clamping portion 112 that has a semi-cylindrical clamping surface 114. The second collar part 110 also includes flanges 116 positioned on opposite sides of the clamping portion 112. The second collar part 110 also includes a protuberance 118 that protrudes from the clamping surface 114 of the clamping portion 112.

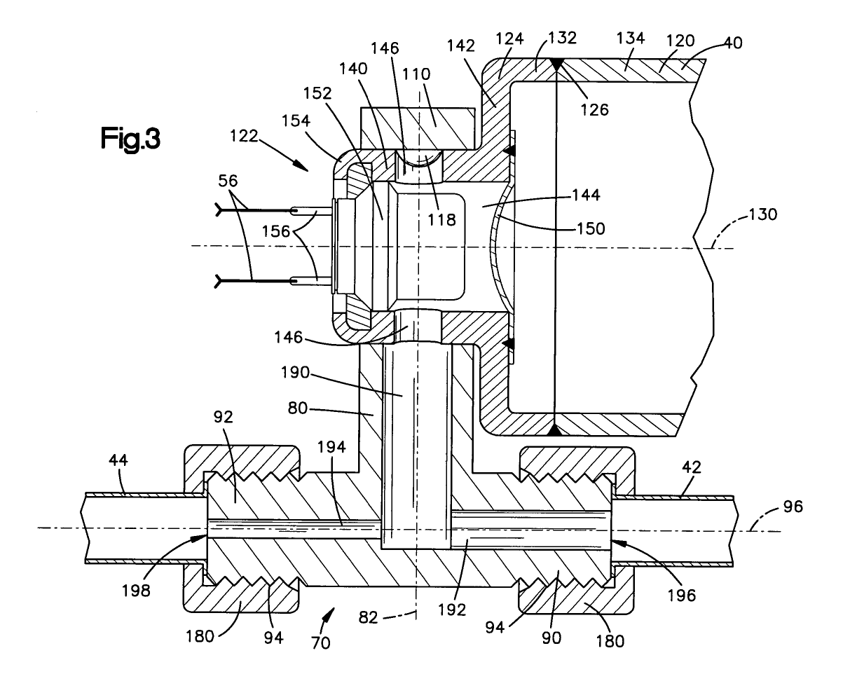

The inflator 14 includes a container portion 120 and an outlet assembly 122 that is fixed to the container portion. The container portion 120 forms a vessel for storing inflation fluid under pressure. Referring to FIGS. 2 and 3, the outlet assembly 122 includes a diffuser 124 connected with the container portion 120. The diffuser 124 has a cylindrical first side wall portion 132 having a diameter about equal to a diameter of a cylindrical side wall 134 of the container portion 120. The container portion 120 and outlet assembly 122 are aligned with each other along an axis 130. Terminal ends of the side walls 132 and 134 are butted against each other and connected with each other by means 126, such as a weld.

The diffuser 124 also includes a cylindrical second side wall portion 140 that has a diameter smaller than the first side wall portion 132. An annular shoulder portion 142 extends radially between the first and second side wall portions 132 and 140. The second side wall 140 helps define a chamber 144 of the diffuser 124. The diffuser includes a pair of outlet apertures 146 that extend through the second side wall 140 and provide fluid communication between the chamber 144 and the exterior of the inflator 14. The outlet apertures 146 combine together to define an outlet flow area of the inflator 14.

The outlet apertures 146 are positioned radially opposite each other on the second side wall 140 and have cross-sectional areas that are about equal to each other. The outlet apertures 146 may thus provide what is referred to in the art as a “thrust neutral” inflator design.

The outlet assembly 122 also includes rupturable means 150, such as a burst disk, that is connected to the shoulder portion 142 of the diffuser 122 by means such as welding or an adhesive. The burst disk 150, when connected to the diffuser 122 as shown in FIG. 3, blocks fluid communication between the container portion 120 and the chamber 144. As shown in FIG. 3, the burst disk 150 may have a domed central portion that extends into the chamber 144 and a radially extending flange portion connected to the shoulder portion 142.

The outlet assembly 122 also includes an initiator 152 that is actuatable to rupture the burst disk 150. The initiator 152 is supported in the chamber 144 by suitable means, such as by crimping an end portion 154 of the second side wall 140 over the initiator. As known in the art, the initiator 152 includes a body of pyrotechnic material (not shown) that is ignitable to effectuate the rupture of the burst disk 150. Ignition of the pyrotechnic material is initiated by an electrical signal provided to pins 156 of the initiator 152 via the lead wires 56 (see also FIG. 1).

Referring to FIGS. 2 and 3, the collar portion 72 is operable to connect the manifold 70 to the inflator 14. The first and second collar parts 100 and 110 are positioned relative to each other such that the respective clamping surfaces 104 and 114 of the clamping portions 102 and 112 are presented facing toward each other. The diffuser 122 is positioned between the opposing clamping surfaces 104 and 114. The first and second collar parts 100 and 110 are brought together such that the clamping surfaces 104 and 114 engage respective radial portions of the second side wall 140. The semi-cylindrical clamping surfaces 104 and 114 may thus combine to form a cylindrical clamping surface that encircles the second side wall 140.

The flange portions 106 and 116 are fastened together by means 170, such as machine screws. The screws 170 are tightened to clamp the diffuser 124 between the first and second clamping parts 100 and 110. The diameter of the cylindrical clamping surface formed by the clamping surfaces 104 and 114 may be smaller than the diameter of the outer surface of the second side wall 140, which may help increase the clamping force exerted on the second side wall 140 by the clamping parts 100 and 110.

The first and second fill tubes 42 and 44 may be connected to the first and second distribution portions 90 and 92, respectively, by threaded caps 180. The caps 180 may slide over the fill tubes 42 and 44 and form a threaded connection with the threads 94 on the distribution portions 90 and 92. When the caps 180 are fully engaged with the distribution portions 90 and 92, the fill tubes 42 and 44 may thus be connected to the manifold 70 by a compression fitting. It will be appreciated, however, that alternative means, such as welding, may be used to connect the fill tubes 42 and 44 to the manifold 70.

In the assembled condition of the apparatus 10 shown in FIG. 3, the protuberance 118 on the second collar part 110 extends into one of the apertures 146 and helps block inflation fluid flow through that aperture. Also, in the assembled condition, the aperture 146 opposite the protuberance 118 provides fluid communication between the chamber 144 and a main fluid passage 190 of the manifold 70. The main fluid passage 190 extends along the axis 82 through the first flange portion 100 and the main fluid passage portion 80 of the manifold 70.

The main fluid passage 190 terminates at a location where the main fluid passage portion 80 intersects the first and second fluid distribution portions 90 and 92. As shown in FIG. 3, the axes 82 and 96 along which the main fluid passage portion 80 and the fluid distribution portions 90 and 92 extend intersect perpendicularly with each other. The manifold 70 thus takes on a generally T-shaped configuration (inverted as viewed in FIG. 3).

The main fluid passage 190 intersects a first fluid distribution passage 192 of the first distribution portion 90 and a second fluid distribution passage 194 of the second distribution portion 92. The first fluid distribution passage 192 extends through the first distribution portion 90 and provides fluid communication between the main fluid passage 190 and the first fill tube 42. The second fluid distribution passage 194 extends through the second distribution portion 92 and provides fluid communication between the main fluid passage 190 and the second fill tube 44.

As shown in FIG. 3, the first fluid distribution passage 192 has a diameter that is larger than the diameter of the second fluid distribution passage 194. Upon actuation of the inflator 40, inflation fluid is released into the main fluid passage 190 through the diffuser 124. The pressurized inflation fluid flows through the main fluid passage 190 and into the first and second fluid distribution passages 192 and 194, respectively.

The main fluid passage 190 has a cross-sectional area that is larger than the respective cross-sectional areas of the first and second fluid distribution passages 192 and 194. The first fluid passage 192 thus acts as a first flow orifice 196 that helps control or limit inflation fluid flow through the first fluid distribution portion 90 and into the first fill tube 42. The second fluid passage 194 similarly acts as a second flow orifice 198 that helps control or limit inflation fluid flow through the second fluid distribution portion 92 and into the second fill tube 44. The first fluid passage 192 directs inflation fluid to flow in a first direction, to the right as viewed in FIG. 3. The second fluid passage 194 directs inflation fluid to flow in a second direction, opposite the first direction, to the left as viewed in FIG. 3.

The manifold 70 is thus operative to help direct inflation fluid from the inflator 14 into the first fill tube 42 and second fill tube 44 at different flow rates. The manifold 70 directs inflation fluid into the first fill tube 42 at a flow rate greater than the flow rate at which the manifold directs inflation fluid into the second fill tube 44. Inflation fluid may thus be directed into the front and rear portions 50 and 52 (FIG. 1) of the inflatable curtain 14 at desired rates commensurate with the respective volumes of the front and rear portions.

Advantageously, the manifold 70, being separate from and connectable with the inflator 40, allows for versatile implementation of the apparatus 10. For example, those skilled in the art will appreciate that the configuration of an inflatable curtain 14 may vary depending on factors such as the architecture of the particular vehicle in which the curtain is installed. As a result, it may be desirable to alter or vary the flow rate at which inflation fluid is directed into different portions of the inflatable curtain 14 to account for varying configurations of the curtain.

According to the present invention, this may be accomplished by implementing a manifold 70 configured to deliver inflation fluid into the first and second fill tubes 42 and 44 at flow rates commensurate with the configuration of the inflatable curtain 14. As a result, no alteration or modification of the structure of the inflator 40 is required. Thus, by using different manifold 70 constructions, a inflator 40 having a single construction may be used to deliver inflation fluid at a variety of respective flow rates into the first and second fill tubes 42 and 44.

As a further benefit, this same inflator 40 may be used without the manifold 70 in configurations where a single fill tube is used to deliver inflation fluid to the inflatable curtain 14. Through the addition of the manifold 70, this same inflator may be used to deliver inflation fluid into first and second fill tubes at different flow rates.

For example, in the case where a vehicle may include third row seating, a side curtain configuration that covers the third row seats may be desired. If third row seating is not included, then the inflatable curtain 14 is dimensioned and configured to help protect occupants in first and second row seats. In this instance, the inflator 40 may be used with a single fill tube to deliver inflation fluid to the inflatable curtain 14. If third row seating is included, then the inflatable curtain 14 is dimensioned and configured to help protect occupants in first, second, and third row seats. In this instance, the manifold 70 and another fill tube may be added to the configuration of the apparatus 10. In this configuration, the inflator 40 may provide inflation fluid to the first fill tube 42 to deliver inflation fluid to the portion of the curtain for helping to protect occupants of the first and second row seats, and may provide inflation fluid to the second fill tube 44 to deliver inflation fluid to the portion of the curtain for helping to protect occupants of the third row seats. Advantageously, the construction of the inflator 40 need not be altered in either of the configurations set forth above.

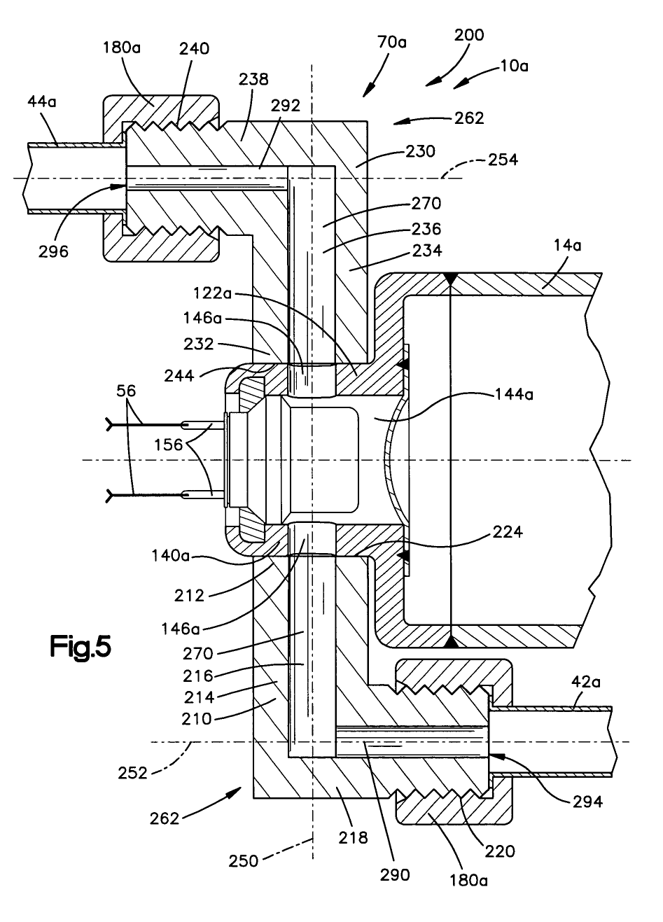

A second embodiment of the present invention is illustrated in FIGS. 4 and 5. The second embodiment of the invention is similar to the first embodiment of the invention illustrated in FIGS. 1-3. Accordingly, numerals similar to those of FIGS. 1-3 will be utilized in FIGS. 4 and 5 to identify similar components, the suffix letter “a” being associated with the numerals of FIGS. 4 and 5 to avoid confusion. The second embodiment of the present invention is similar to the first embodiment (FIGS. 1-3), except that the manifold of the second embodiment has a different configuration than the manifold of the first embodiment.

Referring to FIGS. 4 and 5, the apparatus 10a of the second embodiment includes an inflation fluid distribution manifold 200 for directing inflation fluid from the inflator 40a into the first and second fill tubes 42a and 44a. The manifold 200 includes first and second manifold parts 210 and 230, respectively, that have similar configurations.

The first manifold part 210 includes a first collar part 212 and a first fluid passage part 214. The first fluid passage part 214 includes a first fluid passage 216 that is centered on and extends along an axis 250. The first manifold part 210 also includes a first fluid distribution part 218 that extends along an axis 252 perpendicular to the axis 250. The first fluid distribution part 218 has a generally cylindrical configuration and includes a series of screw threads 220 on its outer surface.

The first collar part 212 includes a central clamping portion 222 that has a semi-cylindrical clamping surface 224. The first collar part 212 also includes flanges 226 positioned on opposite sides of the clamping portion 222.

The second manifold part 230 includes a second collar part 232 and a second fluid passage part 234. The second fluid passage part 234 includes a second fluid passage 236 (see FIG. 5) that is centered on and extends along the axis 250. The second manifold part 230 also includes a second fluid distribution part 238 that extends along an axis 254 perpendicular to the axis 250 and is spaced from and parallel to the axis 252. The second fluid distribution part 238 has a generally cylindrical configuration and includes a series of screw threads 240 on its outer surface.

The second collar part 232 includes a central clamping portion 242 that has a semi-cylindrical clamping surface 244. The second collar part 232 also includes flanges 246 positioned on opposite sides of the clamping portion 242.

Referring to FIG. 4, the first and second collar parts 212 and 232 together form a collar portion 260 of the manifold 200 that is adapted to connect with the inflator 14a. The first and second fluid passage parts 214 and 234 and the first and second fluid distribution parts 218 and 238 together form a fluid distribution portion 262 of the manifold 200 that is adapted to connect with the first and second fill tubes 42a and 44a. The collar portion 260 receives inflation fluid from the inflator 14a and directs the fluid to the fluid distribution portion 262. The distribution portion 262, in turn, directs the inflation fluid to the fill tubes 42a and 44a at desired flow rates.

The inflator 14a of the second embodiment is identical to the inflator of the first embodiment described above. Referring to FIGS. 4 and 5, the collar portion 260 is operable to connect the manifold 200 to the inflator 14a. The first and second collar parts 212 and 232 are positioned relative to each other such that the respective clamping surfaces 224 and 244 of the clamping portions 222 and 242 are presented facing toward each other. The diffuser 122a is positioned between the opposing clamping surfaces 224 and 244. The first and second collar parts 212 and 232 are brought together such that the clamping surfaces 224 and 244 engage respective radial portions of the second side wall 140a. The semi-cylindrical clamping surfaces 224 and 244 may thus combine to form a cylindrical clamping surface that encircles the second side wall 140a.

The flange portions 226 and 246 are fastened together by means 170a, such as machine screws. The screws 170a are tightened to clamp the diffuser 124a between the first and second clamping parts 212 and 232. The diameter of the cylindrical clamping surface formed by the clamping surfaces 224 and 244 may be smaller than the diameter of the outer surface of the second side wall 140a, which may help increase the clamping force exerted on the second side wall 140a by the clamping parts 212 and 232.

The first and second fill tubes 42a and 44a may be connected to the first and second distribution portions 218 and 238, respectively, by threaded caps 180a. The caps 180a may slide over the fill tubes 42a and 44a and form a threaded connection with the threads 220 and 240 on the distribution portions 218 and 238, respectively. When the caps 180a are fully engaged with the distribution portions 218 and 238, the fill tubes 42a and 44a may thus be connected to the manifold 200 by a compression fitting. It will be appreciated, however, that alternative means, such as welding, may be used to connect the fill tubes 42a and 44a to the manifold 200.

In the assembled condition of the apparatus 10a shown in FIG. 5, the apertures 146a provide fluid communication between the chamber 144a and a main fluid passage 270 of the manifold 200. The first and second fluid passages 216 and 236 together define the main fluid passage 270 (see FIG. 5).

The first fluid passage 216 terminates at a location where the first fluid passage part 214 intersects the first fluid distribution part 218. The second fluid passage 236 terminates at a location where the second fluid passage part 234 intersects the second fluid distribution part 238. As shown in FIG. 5, the axes 250 and 252 along which the first fluid passage part 214 and the first fluid distribution part 218 extend intersect perpendicularly with each other. The axes 250 and 254 along which the second fluid passage part 234 and the second fluid distribution part 238 also extend perpendicularly with each other. The first and second fluid distribution parts 218 and 238 extend away from each other in opposite directions. The manifold 200 thus takes on a generally S-shaped configuration (reversed, as shown in FIG. 5).

The first fluid passage 216 intersects a first fluid distribution passage 290 of the first distribution part 218. The first fluid distribution passage 290 extends through the first distribution part 218 and provides fluid communication between the first fluid passage 216 and the first fill tube 42a.

The second fluid passage 236 intersects a second fluid distribution passage 292 of the second distribution part 238. The second fluid distribution passage 292 extends through the second distribution part 238 and provides fluid communication between the second fluid passage 236 and the second fill tube 44a.

As shown in FIG. 5, the first fluid distribution passage 290 has a diameter that is larger than the diameter of the second fluid distribution passage 292. Upon actuation of the inflator 14a, inflation fluid is released into the main fluid passage 270 through the diffuser 124a. More specifically, inflation fluid is released into the first and second fluid passages 216 and 236 by respective ones of the outlet apertures 146a in the diffuser 124a. The pressurized inflation fluid flows through the first and second fluid passages 216 and 236 into the first and second fluid distribution passages 290 and 292, respectively.

The first fluid passage 290 acts as a first flow orifice 294 that helps control or limit inflation fluid flow through the first fluid distribution part 218 and into the first fill tube 42a. The second fluid passage 292 acts as a second flow orifice 296 that helps control or limit inflation fluid flow through the second fluid distribution part 238 and into the second fill tube 44a. The first fluid passage 290 directs inflation fluid to flow in a first direction, to the right as viewed in FIG. 5. The second fluid passage 292 directs inflation fluid to flow in a second direction, opposite the first direction, to the left as viewed in FIG. 5.

The manifold 200 is thus operative to help direct inflation fluid from the inflator 14a into the first fill tube 42a and second fill tube 44a at different flow rates. In the embodiment illustrated in FIGS. 4 and 5, the manifold 200 directs inflation fluid into the first fill tube 42a at a flow rate greater than the flow rate at which the manifold directs inflation fluid into the second fill tube 44a. Inflation fluid may thus be directed into the front and rear portions 50 and 52 (see FIG. 1) of the inflatable curtain 14 at desired rates commensurate with the respective volumes of the front and rear portions.

From the above description of the invention, those skilled in the art will perceive improvements, changes and modifications. Such improvements, changes and modifications within the skill of the art are intended to be covered by the appended claims.

1. Apparatus for helping to protect an occupant of a vehicle that has a side structure and a roof, said apparatus comprising:
an inflatable curtain that is inflatable away from the roof between the side structure of the vehicle and a vehicle occupant, said inflatable curtain having an inflatable volume;
an inflator actuatable to provide inflation fluid for inflating said inflatable curtain;
a first fill tube having a portion positioned in a first portion of said inflatable volume;
a second fill tube having a portion positioned in a second portion of said inflatable volume; and
an inflation fluid distribution manifold connectable with said inflator, said manifold comprising a first flow orifice that directs inflation fluid to flow into said first fill tube at a first flow rate and a second flow orifice that directs inflation to fluid flow into said second fill tube at a second flow rate different than said first flow rate.

2. The apparatus recited in claim 1, wherein said manifold comprises:
a main fluid passage;
a collar portion connectable with said inflator to provide fluid communication between said inflator and said main fluid passage;
a first distribution portion connectable with said first fill tube, said first distribution portion providing fluid communication between said first fill tube and said main fluid passage, said first distribution portion including said first flow orifice; and
a second distribution portion connectable with said second fill tube, said second distribution portion providing fluid communication between said second fill tube and said main fluid passage, said second distribution portion including said second flow orifice.

3. The apparatus recited in claim 2, wherein said inflator comprises a container and an outlet assembly, said outlet assembly comprising an outlet flow area and means actuatable to release inflation fluid to flow from said container through said outlet flow area, said collar portion being connectable with said outlet assembly to provide fluid communication between said main fluid passage and said outlet flow area.

4. The apparatus recited in claim 3, wherein said outlet assembly comprises a diffuser having a generally cylindrical configuration, said collar portion having a generally cylindrical surface for mating with and clamping onto said diffuser to connect said manifold to said inflator.

5. The apparatus recited in claim 4, wherein said outlet flow area of said outlet assembly comprises first and second outlet apertures positioned radially opposite each other about said diffuser, said main fluid passage being positioned adjacent said first outlet aperture when said collar portion is connected with said diffuser, said collar portion including a protuberance positioned opposite said main fluid passage and extendable into said second outlet aperture when said collar portion is connected with said diffuser.

6. The apparatus recited in claim 2, wherein said collar portion comprises:
a first collar part having an inner surface;
a second collar part separate from said first collar part, said second collar part having an inner surface; and
fastening means for connecting said first and second collar parts with each other, said inner surfaces of said first and second collar parts together defining a clamping surface of said collar portion when said first and second collar parts are connected with each other.

7. The apparatus recited in claim 6, wherein said clamping surface extends around and clamps onto an outer surface of said inflator when said first and second collar parts are connected with each other.

8. The apparatus recited in claim 6, wherein each of said inner surfaces of said first and second collar parts has a generally semi-cylindrical configuration, said clamping surface having a generally cylindrical configuration when said first and second collar parts are connected with each other.

9. The apparatus recited in claim 2, wherein said manifold has a generally T-shaped configuration, said main fluid passage extending along a first axis, said first and second distribution portions extending in opposite directions along a second axis perpendicular to said first axis from a first end of said main fluid passage.

10. The apparatus recited in claim 9, wherein said collar portion comprises:
a first collar part formed at a second end of said main fluid passage opposite said first end, said first collar part having a semi-cylindrical inner surface;
a second collar part separate from said first collar part, said second collar part having a semi-cylindrical inner surface; and
fastening means for connecting said first and second collar parts with each other, said semi-cylindrical surfaces of said first and second collar parts together defining a cylindrical inner surface of said collar portion when said first and second collar parts are connected with each other.

11. The apparatus recited in claim 10, wherein said first collar part includes an aperture that provides fluid communication with said main fluid passage through said inner surface of said first collar portion.

12. The apparatus recited in claim 11, wherein said inflator comprises first and second outlet apertures positioned opposite each other, said aperture of said first collar part being positioned adjacent said first outlet aperture when said collar portion is connected with said inflator, said second part including a protuberance extendable into said second outlet aperture when said collar portion is connected with said inflator.

13. The apparatus recited in claim 2, wherein said manifold has a generally S-shaped configuration, said main fluid passage having a first portion extending from said collar portion in a first direction along a first axis, said main fluid passage having a second portion extending from said collar portion in a second direction opposite said first direction along said first axis, said first distribution portion extending perpendicularly from an end of said first portion of said main fluid passage opposite said collar portion, said second distribution portion extending perpendicularly from an end of said second portion of said main fluid passage opposite said collar portion.

14. The apparatus recited in claim 13, wherein said collar portion comprises:
a first collar part formed at an end of said first portion of said main fluid passage opposite said first distribution portion, said first collar part having a semi-cylindrical inner surface;
a second collar part separate from said first collar part, said second collar part being formed at an end of said second portion of said main fluid passage opposite said first distribution portion, said second collar part having a semi-cylindrical inner surface; and
fastening means for connecting said first and second collar parts with each other, said semi-cylindrical surfaces of said first and second collar parts together defining a cylindrical inner surface of said collar portion when said first and second collar parts are connected with each other.

15. The apparatus recited in claim 14, wherein said first collar part includes an aperture that provides fluid communication with said first portion of said main fluid passage through said inner surface of said first collar portion, and said second collar part includes an aperture that provides fluid communication with said second portion of said main fluid passage through said inner surface of said second collar portion.

16. The apparatus recited in claim 15, wherein said inflator comprises first and second outlet apertures positioned opposite each other, said aperture of said first collar part being positioned adjacent said first outlet aperture when said collar portion is connected with said inflator, said aperture of said second collar part being positioned adjacent said second outlet aperture when said collar portion is connected with said inflator.

17. The apparatus recited in claim 2, wherein said first distribution portion directs said inflation fluid in a first direction and said second distribution portion directs said inflation fluid in a second direction, opposite said first direction.

18. The apparatus recited in claim 1, wherein said inflator comprises an outlet portion for releasing inflation fluid to flow from said inflator, said manifold comprising a collar portion connectable with said outlet portion of said inflator.

19. An inflation fluid distribution manifold for directing inflation fluid from an inflator to an inflatable curtain inflatable away from a vehicle roof between a side structure of the vehicle and a vehicle occupant, said manifold comprising:
a collar portion comprising first and second collar parts each having an inner surface, said first and second collar parts being connectable with each other such that said inner surfaces encircle and engage an outlet portion of the inflator to clamp said collar portion onto the outlet portion of the inflator;
a main fluid passage in fluid communication with an inflation fluid outlet of the outlet portion while said collar portion is clamped onto the outlet portion of the inflator;
a first distribution passage in fluid communication with said main fluid passage, said first distribution passage comprising a first flow orifice that helps direct inflation fluid to flow into the inflatable curtain at a first flow rate; and
a second distribution passage in fluid communication with said main fluid passage, said second distribution passage comprising a second flow orifice that helps direct inflation fluid to flow into the inflatable curtain at a second flow rate different than said first flow rate.

20. The apparatus recited in claim 19, wherein said inner surfaces of said first and second collar parts combine to form a cylindrical clamping surface of said collar portion, said cylindrical clamping surface being in continuous engagement with a cylindrical outer surface of said outlet portion of said inflator while said collar portion is clamped onto the outlet of the inflator.
